(19) United States
(12) Patent Application Publication
(10) Pub. No.: US 2014/0110004 A1
(43) Pub. Date: Apr. 24, 2014

(54) MULTIPLE-LAYER ELECTRICALLY HEATABLE MEDIUM LINE

(71) Applicants: Jörg Westmeier, Krefeld (DE); Otfried Schwarzkopf, Kurten (DE); Thomas Schüler, Gummersbach (DE)

(72) Inventors: Jörg Westmeier, Krefeld (DE); Otfried Schwarzkopf, Kurten (DE); Thomas Schüler, Gummersbach (DE)

(73) Assignee: VOSS AUTOMOTIVE GMBH, Wipperfürth (DE)

(21) Appl. No.: 14/112,151

(22) PCT Filed: Apr. 17, 2012
(86) PCT No.: PCT/EP2012/001663

§ 371 Date: Nov. 20, 2013

(30) Foreign Application Priority Data
Apr. 19, 2011 (DE) 10 2011 018 243.8

(51) Int. Cl. F16L 53/00

(52) U.S. Cl. CPC F16L 53/008
USPC 138/33; 427/105; 118/500

(57) ABSTRACT

In a multiple-layer electrically heatable medium line having a medium-resistant inner layer, a heating layer which is provided with at least two conductors or heating conductors, and an outer layer, the layers of the medium line are single-layer or multiple-layer, and the conductors or heating conductors are embedded within the heating layer such that they are coiled in the longitudinal direction of the medium line, in a radially and/or axially predefined position.

### FIELD OF THE INVENTION

The invention relates to a multi-layer electrically heatable medium line having a medium-resistant inner layer, a heating layer which is provided with at least two conductors, and an outer layer, as well as to a method for manufacturing such a multi-layer heatable medium line.

### BACKGROUND OF THE INVENTION

Electrically heatable medium lines and methods for their manufacture are known from the state of the art. In particular in vehicles, a number of medium lines are provided for conducting mostly liquid media. These media lines are liable to freeze up at low temperatures, wherefore they are provided with heating. Connecting elements serve to connect at least two medium lines or to connect a medium line with a given aggregate. The media flowing in the medium lines are often media which due to a relatively high freezing point tend to freeze even in quite high ambient temperatures, which can have a negative impact on their operability or even cause severe malfunctioning. This is particularly noticeable in medium lines where the medium is an aqueous urea solution, which is used as a NOₓ reaction additive for Diesel engines with so-called SCR catalyzers. The heating layer of the medium line serves to heat the medium line, wherein the heating layer is a plastic layer generating heat because of its electrical resistance, and the conductors are configured as contact pins or electric resistance-heating conductors and thereby enable heating or, as heating conductors, provide heat transfer into the heating layer.

For example, the WO 2010/080890 A1 discloses an electrically heated flexible liquid line with an elongated flexible pipe body which comprises an electric resistance-heating facility. The liquid flow path is surrounded by this. In a variant of the embodiment heat-generating electric flow paths are formed by an electric wire in the pipe body which is arranged around the liquid flow path, crossing two electric supply lines in numerous places. In another variant of the embodiment the heat-generating liquid flow path contains a layer consisting of electrically conducting polymers within the pipe body and surrounding the liquid flow path. Either the entire pipe body consists of electrically conducting polymers or the polymer layer is arranged between two electrically non-conducting layers. The electric supply lines are connected with an electric energy source via electric connections, wherein the electric connections may be arranged at the same end of the pipe body, at opposite ends of, or along the pipe body.

The DE 20 2005 004 602 U1 discloses a heatable liquid line with electric lines embedded in the sheathing of the liquid line. Here the plastic tube through which the liquid flows, forms an innermost layer which is surrounded by an intermediate layer of an electrically conducting polymer with a positive temperature characteristic of the electric resistance and electric lines embedded therein, wherein the outer layer consisting of an insulating material surrounds the line on the outside. The intermediate layer is disclosed as a thermoplastic polymer with electrically conducting particles in the form of a PTC polymer layer, which is extruded onto the innermost layer.

The EP 2 201 229 B1 has disclosed a method for manufacturing a line system for conveying aqueous urea solutions, wherein the line system comprises a fluid line comprising a section which has a heating conductor wrapped around it. This section of the line system further comprises a sheathing from a polymer material covering the heating conductor in this section. Prior to the heating conductor being wrapped around the section along the entire specified length, the polymer material layer is wrapped around areas of the section around which the heating conductor has already been wrapped, until the section along at least a part of the specified length has been wrapped by the polymer material layer, thus forming the sheathing which surrounds the section and covers the heating conductor. The polymer material layer is produced by extrusion.

From the DE 37 30 580 C1 an electrically heated tube is known where electrodes are embedded into the sheathing of the tube with a homogenous conducting layer arranged between them, which forms the tube wall. The electrically conducting layer consists of a mixture of a polymer basic material and soot or graphite, the electrodes consist of copper strands or of a conducting plastic.

### SUMMARY OF THE INVENTION

The present invention is based on the requirement to provide a multi-layer electrically heatable medium line with improved contactability and to obtain an improved automation capability during manufacture of a multi-layer electrically heatable medium line, thereby enabling the manufacturing process of the medium line to be optimized.

This requirement is met by a multi-layer electrically heatable medium line according to the preamble of claim 1 in that the conductors or heating conductors, in longitudinal direction of the medium line, are embedded coiled in a predetermined radial and/or axial position within the heating layer. With a method for manufacturing a multi-layer electrically heatable medium line the requirement is met in that a single-layer or multi-layer inner layer is manufactured, a first layer of a heating layer is applied to the inner layer for arranging conductors or heating conductors in a defined position in the wall of the medium line, at least two conductors or heating conductors are applied onto the first layer of the heating layer, a second layer of the heating layer is applied, wherein the conductors or heating conductors are embedded into the second heating layer, and a single- or multi-layer outer layer is applied onto the second or at least one further heating layer, or, in that a single- or multi-layer inner layer is manufactured, a heating layer as a single- or multi-layer layer is applied to the inner layer, the heating layer is locally heated for partially melting on or is heated, at least two conductors or heating conductors are embedded into the melted-on heating layer in a coiled arrangement along the longitudinal extension of the medium line, and a single- or multi-layer outer layer is applied onto the heating layer, or in that a single- or multi-layer inner layer is manufactured, a single- or multi-layer heating layer is applied to the inner layer, a single- or multi-layer outer layer is applied to the heating layer, at least two conductors or heating conductors are heated and, prior to or after applying the outer layer, are introduced into the heating layer up to a predefined depth from the respective outside of the heating layer or outer layer. Further developments of the invention are defined in the dependent claims.

In this way a multi-layer electrically heatable medium line is created, which enables easier contacting to be achieved for connecting a connecting element for connecting the medium line to an aggregate, since the position of the conductors or heating conductors embedded within the heating layer is predetermined and defined. Predetermining the radial and/or axial position of the conductors or heating conductors is understood to mean unequivocally arranging, in advance in a considered manner, the conductors or heating conductors in a desired radial and/or axial position with regard to the heating layer and at a previously fixed pitch relative to the longitudinal axis of the medium line. Following covering the conductors or heating conductors with a material layer (a further layer of the heating layer and/or of the outer layer(s)) the position of the conductors or heating conductors is thus known and unequivocally defined in view of the knowledge of the manufacturing parameters and can be determined since it was specified when embedding the conductors or heating conductors. The position of the conductors or heating conductors is therefore not accidental as with the medium lines of the state of the art, but is unequivocally defined radially and/or axially by certain parameters during manufacture.

Especially due to predetermining the radial position of the conductors or heating conductors in the heating layer there is no longer any dependency on the tolerance of the other layers of the medium line, meaning that the position of the conductors or heating conductors in the heating layer is unequivocal. It is therefore possible to manufacture the medium line as an infinite pipe, cut it to the desired length and contact it directly. Processing time is shorter than with known contacting processes. The electrical conductors or heating conductors can be contacted, in particular, by removing the outer layer in merely a desired window and then effecting the contacting. The outer layer can be removed tangentially relative to the medium line, in depth direction, i.e. radially relative to the medium line, axially in longitudinal direction of the medium line or in a circular fashion around the medium line. The conductors or heating conductors can be contacted to form a material bond, and/or the contacts can be formed by melting down. A connecting element or contour for connecting the medium line with a further medium line or an aggregate can be injection-molded onto the end prepared for connection, or the medium line can be overmolded at its end with a fluidic and/or electrical connecting contour.

Contacting the conductors or heating conductors is therefore performed by merely exposing a small window by softening the material layer(s) in direction of the outside of the medium line above the conductors or heating conductors and soldering the respective cables or contacts to the conductors or heating conductors. Since the radial and axial position of the conductors or heating conductors is known, it is sufficient to merely expose a small window for contacting, which window is defined relative to the longitudinal axis and the radial extension of the medium line. The tolerances of the outer layers of the medium line are thus irrelevant for the connection process because the layers above the conductors or heating conductors to be contacted are removed so that it is known due to having knowledge of the position of the conductors or heating conductors, at which point windowing shall be effected. Due to knowing the position of the conductors or heating conductors contacting is simplified and improved in comparison to known medium lines, because the conductors or heating conductors need to be exposed in only a small area (window) but remain protected across the remaining extension of the medium line into its wall.

In principle it is possible to push the heated contacts already provided with solder, from the outside of the medium line through its wall up to the conductors or heating conductors and to directly solder them onto these, wherein due to being heated the layers of the wall become soft and permit the passing-through of the contacts. Because the position of the conductors or heating conductors is known the window can be kept to a minimum size, i.e. essentially corresponds to the diameter of the heated contacts. Using the window technique instead of the commonly used exposure technique across a large area in order to contact the conductors or heating conductors permits short processing times or allows a quick connection of an electric plug for connecting the conductors or heating conductors to a power/voltage supply.

Advantageously provision is made for a barrier layer, in particular a laser-impermeable barrier layer, between the heating layer and the inner layer, or for a barrier starting from the innermost layer of the conductors or heating conductors in direction of the inner layer, which barrier layer prevents the inner layer from becoming soft and thus damaged. Barrier layers may also be provided between the other layers of the medium line. Or the medium line can be provided with a barrier layer on the outside of the medium line.

Due to the defined position of the conductors or heating conductors within the heating layer, targeted and partially also more intensive heating can be effected within a predetermined area within or along the wall of the medium line, wherein the conductors or heating conductors may e.g. be arranged directly adjacent to the inner layer and/or directly adjacent to the outer layer and/or in one or more positions in between. Depending upon the chosen position and the number of conductors or heating conductors in an area, the medium flowing within the medium line can be heated faster. Especially in cases where several layers of +/− conductors or heating conductors are provided individual conductors can be connected or disconnected providing for an additional control of the heating operation of the medium line. Since the heating layer is advantageously kept as thin as possible, in particular below 1 mm, so as to keep the increase in wall thickness of the medium lines compared to conventional medium lines almost unchanged due to using several layers of conductors or heating conductors in the construction, the conductors or heating conductors can be arranged across the circumference of the medium line wall in a distributed or offset manner. Selective connecting and disconnecting of individual conductors or heating conductors permits selective heating of the medium line during subsequent installation in desired areas.

The pitch of the conductors or heating conductors arranged in a coiled manner may vary across the longitudinal extension of the medium line. This means that the pitch of the conductors or heating conductors can be arranged so as to vary in sections across the longitudinal extension of the medium line. Knowledge of the axial position of the conductors or heating conductors is thus extremely helpful for quick contacting.

Due to providing a coiled arrangement of the conductors or heating conductors along the medium line, this can be bent into shape without conductors or heating conductors tending to change their position which could lead to cracks forming in the wall of the medium line. Also the coiled winding provides for strain relief in the conductors or heating conductors during bending of the medium line, thus offering protection against line breakage. In addition, due to the coiled winding (axial position) and apart from ensuring that the conductors or heating conductors are in a defined radial position within the wall of the medium line, locating the conductors or heating conductors for the purpose of connecting them, is made easy even for an undefined arrangement of the medium line for connection purposes. As an alternative to coiled winding of the conductors these can also be arranged in parallel with the longitudinal axis of the medium line, wherein the conductors or heating conductors in this case advantageously comprise axial extensibility so as not to break when the medium line is bent into shape or not to become detached from the plastic material or the embedding.

The electric conductors or heating conductors are advantageously wrapped at a large pitch, in particular a pitch of 20 to 150 mm, coiled about the pipe part formed by the inner layer for allowing or facilitating the bending-into-shape of the medium line. In contrast to arranging the conductors or heating conductors without such coiling there is now the possibility of bending the medium line into shape even with small radii of curvature and thus to adapt it to suit the respective installation space with respect to its shaping.

Due to arranging the conductors or heating conductors in a predetermined position within the heating layer the break point in case of a suspected line break can be located faster, since the position of the conductors or heating conductors within the heating layer, and thus a fault, can be easily determined from outside, e.g. by voltage or resistance measuring.

Advantageously the conductors or heating conductors are provided with a coating, but without a surrounding insulating layer, i.e. without plastic sheathing. This is possible if the conductors or heating conductors are embedded into a heat-conducting layer. The coating serves as corrosion protection, for example against permeative contact with the medium flowing through the medium line, such as an aqueous urea solution, and may be a metal coating, in particular a nickel or tin coating having, in particular, a coating thickness of 1 to 3 μm. For example, the conductors or heating conductors could consist of a copper material which is provided with a nickel coating. A nickel coating has proven to be particularly advantageous, also in view of the cost, whereas tin-coating, although being even more effective against corrosion then nickel-coating, is considerably more expensive compared to the latter. A layer thickness of 1 to 3 μm of the metallic coating is sufficient for offering good protection against corrosion. In principle an even thicker coating could be provided which, however, has proven to be uneconomical and not as effective as regards heating output. Contacting of the coated electric conductors or heating conductors is effected through the coating of, in particular, the copper conductors or copper heating conductors.

The heating layer may be configured as a heat-conducting or electrically conducting layer, and may consist, in particular, of at least an extrudable plastic material, in particular PA11 and/or PA12. As a heat-conducting layer the heating conductors represent the heat source which heats the heat-conducting layer, wherein the heat is fed through the heat-conducting layer and can thus heat the medium flowing within the medium line, in particular the aqueous urea solution. If the heating layer is configured as an electrically conducting layer, the embedded conductors represent the contact poles, between which the current flows through the conducting and resistive plastic material, and which thus leads to heating the conducting layer and thus to heating the medium line and thus the medium flowing therein. Using an extrudable plastic material makes it easy to apply the heating layer to the inner layer, in particular in the form of several layers, wherein the conductors or heating conductors can also be wound in several layers. Arranging the conductors or heating conductors on a predetermined layer of the heating layer can be accomplished in a simple way by initially extruding a layer of a defined layer thickness onto the inner layer, then applying the conductors or heating conductors onto this first layer, extruding a further layer onto the first layer as well as onto the conductors or heating conductors and, as required, again applying conductors or heating conductors onto the second layer followed by extruding a third layer of the heating layer onto it. In this way a number of layers of a predetermined thickness can be respectively provided with conductors or heating conductors applied thereon so as to form the heating layer. The outer layer can be applied, in particular extruded, onto the last layer of the heating layer. A particularly suitable extrudable plastic material for the heating layer is a conductively filled polyamide such as PA12 or PA11, or another extrudable material. The degree to which the plastic material is filled, is the determining factor as to whether a heat-conducting or an electrically conducting layer is present. In the latter case the conductive particles of the layer touch each other and thereby cause the electrical conductivity. For example 1 to 5% carbon nanotubes or 3 to 15% of a conducting soot can be present in the layer, wherein for a filling with 3% conducting soot a heat-conducting layer can be generated, and for a filling with 15% conducting soot an electrically conducting layer can be generated.

The single-layer or multi-layer inner layer is more medium-resistant than the remaining layers of the medium line and is therefore called medium-resistant. Advantageously the single-layer or multi-layer inner layer or at least one layer of the inner layer is configured as a barrier layer and/or is provided as a barrier layer, in particular a laser-impermeable layer, between the heating layer and the inner layer. The barrier layer, in particular, consists of a fluoropolymer material, for example of one or more of the fluoropolymer materials such as perfluoroethylene propylene plastic (FEP), perfluoroalkoxy alkane (PFA), ethylene tetrafluoroethylene (ETFE), polytetrafluoroethylene (PTFE), wherein the latter material is unsuitable for extruding such an inner layer, so that if PTFE is used, another production method is chosen, or polyvinylidenfluoride (PVDF), which is particularly suitable for use in conjunction with fuel cells. The inner layer thus advantageously consists of a material which stops or prevents a medium flowing within the pipe of the medium line from which it is made, or components thereof such as in particular an aqueous urea solution, from passing through the wall of the pipe. Not only the medium itself but also reaction products thereof such as NH₃ in case of an aqueous solution could, without such a barrier layer, diffuse through the inner layer and lead to damage of the conductors or heating conductors.

The outer layer or covering layer as well as the inner layer may be electrostatically conducting and/or insulating, wherein the inner layer is normally not insulating, but only electrostatically conducting since it could become electrostatically charged due to the friction of the liquid flowing through it. In particular, the outer layer could comprise an insulating foamed outer layer, in particular a chloroprene layer, such as for example a Neopren® or Santropren® layer. Such an electrostatically dissipating effect has proven to be advantageous in preventing negative influences through static charging of the medium line such as when using the medium line in conjunction with fuel cells. Herein the inner layer could also comprise an electrostatically dissipating layer such as a perfluoroethylene propylene plastic (FEP) layer. The outer layer is applied, for example, by overmolding the heating layer onto the outermost layer. The outer layer with its insulating effect may comprise protection against mechanical and possibly also chemical influences.

Additionally or alternatively it is possible to provide an outer insulating and/or protecting element, for example in the form of a corrugated pipe, wherein an air volume is provided as an insulating layer between the corrugated pipe and the outer layer of the medium line. A connecting element or contour may comprise at least one receiving groove for receiving a protecting or insulating element surrounding the medium line, or for receiving a sheathing, e.g. the corrugated pipe. This would be provided for heat insulation and advantageously surrounds the medium line from one connecting element to another. In order to be able to provide a particularly good connection with a connecting contour, it has proven to be of advantage to provide such a receiving groove with means for engaging in the end of the protecting or insulating element or the sheathing. This groove, if the connecting contour is provided in the end region of the medium line, can be directly included in the molding process if the medium line is not configured as an infinite line. Then it is also possible to include or add at least one sealing element, in particular a two-component gasket. Alternatively separate sealing elements can be arranged on the connecting element such as O rings or clamps or hose clips.

Between the inner layer and the heating layer at least one adhesion promoting and/or barrier layer may be provided, in particular a layer from a polymer-modified polyvinylidenfluoride homopolymer (PVDF). The adhesion promoting and/or barrier layer on the one hand serves to provide a bond between the inner layer and the heating layer and on the other hand, serves to prevent the medium, in particular an aqueous urea solution flowing through the medium line within the inner layer, from penetrating into the heating layer. The inner layer is sealed in order to prevent the medium (or part of it) from permeating into the heating layer and thus attacking the conductors or heating conductors. For example, the medium line may be constructed from the following layers, wherein this may comprise, from the inside to the outside, a FEP layer, an adhesion-promoting layer and/or barrier layer, optionally a PA12 layer, a further conductively filled PA12 layer as a heating layer, and an additional PA12 layer as an outer layer or alternatively an insulating foamed outer layer. For the PA12 outer layer, an insulating and/or protecting layer such as a protecting and insulating corrugated pipe may be provided.

Also, the barrier layer may be e.g. configured as a layer-impermeable barrier layer, in order to limit the effect of facilities or production means for exposing the conductors or heating conductors or for removing the covering layer for further production steps.

As least three different processes may be selected for manufacturing such a medium line, these processes being different in that in the first process, at least two layers of the heating layer are superimposed (extruded) on one another, and electrical conductors or heating conductors are applied onto the first layer, and onto each further layer if more further layers are provided. With a second process the single-layer or multi-layer heating layer is locally heated after its manufacture, and the electrical conductors or heating conductors are applied on or embedded into the softened layer. Localized heating may be provided such that at least the outermost layer of the heating layer is heated to melting point or the heating layer is heated to a predetermined depth up to its melting point. Heating may be effected e.g. by flaming, hot air, infrared radiation or laser beam treatment. Other heating methods are also possible. For example the heating layer or the layer of the heating layer into which the conductors or heating conductors shall be embedded may still be warm as a result of being processed so that no additional heating is necessary. Advantageously, if the melting point is exceeded, the heating layer or the respective layer of the heating layer may be cooled in order stop the conductors or heating conductors from penetrating further, thereby ensuring the defined and desired position of the conductors or heating conductors within the heating layer. Where, for example, PA12 is used, the melting temperature is between approx. 165° C. and 185° C., in particular 178° C. so that if a temperature of 185° C. is exceeded, cooling may be provided, in particular an automatically starting cooling process. In order not to exceed the desired penetration depth, a certain time may be specified for flaming or laser beam treatment, or, if using a heated conductor or heating conductor, the force with which the conductor or heating conductor is pressed into the wall of the medium line, may be specified. Further a layer may be locally heated to a defined layer thickness close to its melting point, wherein the desired penetration depth into the layer is reached when the energy used for heating has been used up. This means that the amount of energy specified for the heating source is used up during the heating-up operation so that it is not possible to exceed the desired penetration depth because no further energy is available. The penetration depth can be accurately reached by controlling the governing parameters.

With the third process the electrical conductors or heating conductors are heated and inserted into the heating layer using localized melting-on thereof, from the outside or from the outside of the outer layer. By wrapping with the heated conductors or heating conductors thereon and by applying an adjustable or specified traction force thereupon over a specifiable time these penetrate into the heating layer up to the desired depth and are thus embedded in the heating layer in the desired axial and/or radial position. In particular in order to close the grooves within the protecting outer layer which are created when wrapping the heated conductors or heating conductors thereon from the outside of the outer layer, heating of the outer layer can be provided from the outside. In addition a further protecting layer can be applied to the outer layer, in order to again provide mechanical and chemical protection.

The electrical conductors or heating conductors are, as already mentioned, applied, wound in one or several layers, upon the one or more layers of the heating layer or introduced/embedded into the heating layer.

The layer of the heating layer onto which the conductors or heating conductors are applied, may consist of a material which has a melting point higher than the melting point of the layer(s) above. In this way the conductors or heating conductors if subsequently introduced are prevented from penetrating deeper into the heating layer than desired. Defined positioning of the conductors or heating conductors in the heating layer is therefore possible also in this way.

Advantageously, as already mentioned, at least the layer(s) of the heating layer are applied by extrusion, since this offers a cost-effective solution. It is particularly effective if the conductors or heating conductors are integrated in the heating layer at the same time as extruding the heating layer, using an extruder head with a feeding device for feeding the conductors or heating conductors when extruding the heating layer. Advantageously the conductor or heating conductor feeding device is configured in such a way that conductor or heating conductor output openings are arranged concentrically to an extrusion opening of the extruder head. Instead of a concentric arrangement an arrangement lying radially further on the outside relative to the longitudinal axis is also possible. Also advantageously the conductor or heating conductor feeding device is configured so as to be rotatable about the extrusion opening. This allows coiling of the conductors or heating conductors to be effected during the extrusion process. The conductor or heating conductor feeding device may for example be motorically driven so that the desired coiling pitch can be generated in a precise manner. By varying the draw-off speed during the extrusion process the stiffness of the generated layers or medium line can be varied through stretching.

Due to arranging the electrical conductors or heating conductors in a defined position or in a radial and/or axial position relative to the pipe-shaped medium line, the tolerance chain of the entire wall of the multi-layer medium line is interrupted and thus not of interest, since it is no longer relevant for determining the position of the conductors or heating conductors. Only the tolerance field of the heating layer remains relevant so that the tolerances to be taken into consideration can be reduced.

### BRIEF DESCRIPTION OF THE DRAWINGS

For further explanation embodiments of the invention will be described with reference to the drawing, in which

FIG. 1 shows a cross-sectional view through a pipe line part of a medium line according to the invention, wherein the conductors or heating conductors are arranged at an angle of 180° to each other,

FIG. 2 shows a lateral sectional view as a principal sketch of a not yet completed embodiment of a made-up electrically heatable medium line according to the invention during manufacture,

FIG. 3 shows a lateral sectional view of an embodiment of a made-up electrically heatable medium line of FIG. 1,

FIG. 4 shows a lateral sectional view of another embodiment of a made-up electrically heatable medium line according to the invention,

FIG. 5 shows a cross-sectional view of a further embodiment of a made-up electrically heatable medium line according to the invention,

FIG. 6 shows a lateral sectional view of a further embodiment of a made-up electrically heatable medium line according to the invention, and

FIG. 7 shows a schematic block diagram of a plant for carrying out the method according to the invention during the manufacture of a medium line according to the invention.

### DETAILED DESCRIPTION OF THE DRAWINGS

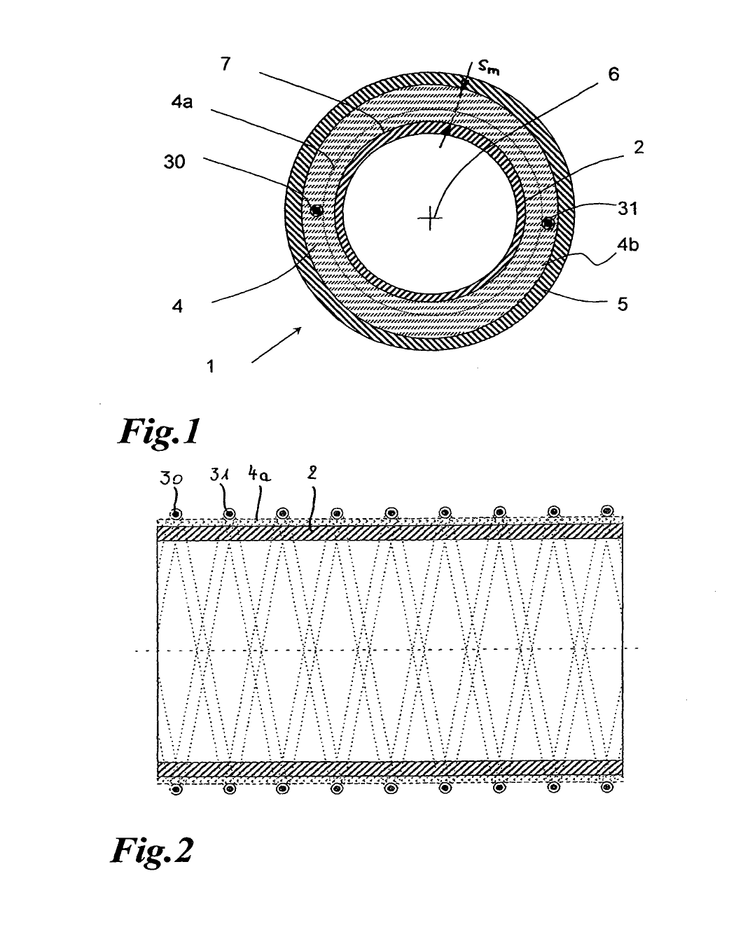

FIG. 1 shows a cross-sectional view of a heatable medium line 1 according to the invention. According to the invention the medium line 1 can be configured as an electrically heatable multi-layer plastic pipe in the form of a so-called MLT pipe (multi-layer technology). The medium line 1 comprises an inner layer 2 which is in contact with the medium flowing within the medium line. Such a medium may, for example, be AdBlue®, a highly pure reducing agent for SCR catalyzer systems (SCR=selective catalytic reduction) in motor vehicles. Alternatively, in fuel cell applications the medium may be hydrogen (H₂) or deionized water. The inner layer may be single-layer or multi-layer and, for example, consist of a polyvinylidenfluoride or an aliphatic polyamide, in particular PA12. The layer thickness may be 01. to 0.3 mm, whereby in principle other layer thicknesses are possible. For other applications, e.g. with fuel cells, the inner layer 2 may also comprise an additional barrier layer not shown, for example a layer from a fluoropolymer material, or the inner layer 2 may totally consist of such a material and/or may comprise an electrostatically dissipating material layer. In particular FEP (perfluoroethylene propylene plastic), PFA (perfluoroalkoxy alkane), ETFE (ethylene tetrafluoroethylene) and PTFE (polytetrafluoroethylene), PVDF (polyvinylidenfluoride) have proven to be advantageous.

Further, according to the invention the medium line 1 comprises a heating layer 4 provided with at least two conductors or heating conductors 30, 31 and an outer layer 5 which may be single-layer or multi-layer. Conveniently the heating layer 4 is configured as a heat-conducting layer or an electrically conducting layer. Preferably it consists of at least one extrudable plastic material, in particular PA11 (polyamide 11) and/or PA12 (polyamide 12). The heating layer 43 may for example have a layer thickness Sₘ of 0.3 to 1.0 mm. It is configured as thinly as possible.

The conductors or heating conductors 30, 31 are coiled in longitudinal direction along the longitudinal axis 6 of the medium line 1, as can be easily recognized in FIGS. 2 to 4. In the embodiment shown two conductors or heating conductors 30, 31 are provided and these are arranged about the longitudinal axis 6, offset by approx. 180°. The two conductors or heating conductors 30, 31 comprise essentially the same pitch along the longitudinal axis 6 of medium line 1, thereby forming two spirals offset in relation to each other without touching each other.

The conductors or heating conductors 30, 31 preferably consist of a coated (plated) copper, preferably a nickel-plated or tin-plated copper wire without an electrically insulating wire sheathing. This is particularly favorable if the plastic material of the heating layer 4 is filled with conducting components such as conducting soot, metal powder, carbon nanotubes etc. and the conductors or heating conductors 30, 31 primarily assume the function of the power supply and comprise different electric potentials. The plastic filled with the electrically conducting components forms the heat source since it has a current flowing through it between the electric conductors serving as poles. For embodiments of the invention, where the conductors or heating conductors 30, 31 shall serve directly as heat source, the conductors or heating conductors 30, 31 may also consist of a heating conductor alloy according to DIN 17 470 or a resistive alloy according to DIN 17 471. The nickel coating or a tin coating preferably comprises a layer thickness of 1 to 3 μm.

Advantageously at least one adhesion promoting and/or barrier layer 7 is provided between the inner layer 2 and the heating layer 4, in particular a layer from a polymer-modified polyvinylidenfluoride homopolymer (PVDF).

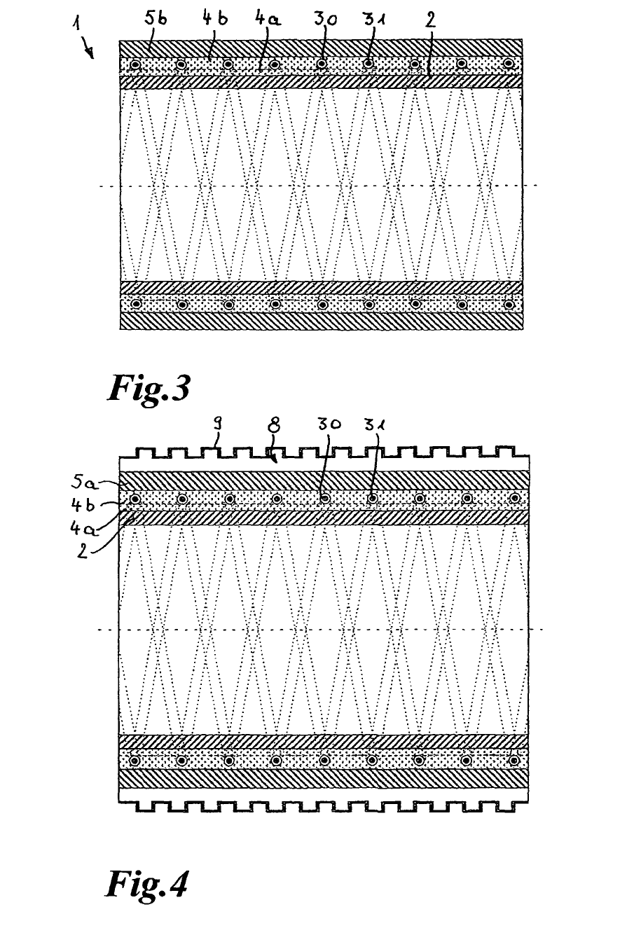

The outer layer 5 may, as already mentioned, be multi-layer and, in particular, comprise layers 5a and/or 5b, such as an insulating foamed outer layer, in particular of a chloroprene rubber, as is possible in the embodiment of the invention in FIG. 3. Alternatively or additionally (see FIG. 4, where the outer layer is configured as an outer polyamide layer 5a) an insulating air layer 8 may be provided within an enveloping corrugated pipe 9, e.g. from PA12. For some applications it is of advantage if the outside of the outer layer 5 or of the corrugated pipe 9 or the inner layer is configured so as to be electrostatically dissipating.

The outer polyamide layer 5a may be single-layer or multi-layer or at least comprise one further layer, such as a barrier layer, in particular an electrostatically dissipating barrier layer. If providing flaming by laser for heating the heating layer 4 for placing the conductors or heating conductors 30, 31 into the same, as will be described in detail below, the barrier layer is advantageously configured so as to be laser-impermeable.

The lateral sectional view (longitudinal section) shown in FIG. 2 shows the state during manufacture of the medium line 1, where the inner layer 2 is already provided with the first layer 4a of the heating layer 4 and the coated conductors or heating conductors 30, 31 arranged thereon. The conductors or heating conductors 30, 31 are wrapped around the first layer 4a, wherein the two conductors or heating conductors 30, 31 are wound in parallel at a radial angular distance of 180°.

The first layer 4a including the conductors or heating conductors 30, 31 applied thereon is then covered by a second layer 4b of the heating layer 4, whereby, in particular, the two layers 4a, 4b are extruded on. It would be possible to place/wind a further one or two layers of the heating layer onto the conductors or heating conductors 30, 31. This process can be repeated several times, until the desired number of heating layers and conductor or heating conductor layers is reached, wherein the conductors or heating conductors can also be partially applied in a multi-layer manner, in order to achieve a locally higher heat input into the medium line.

The outer layer in the form of a chloroprene layer 5b, such as a Santropren® or Neopren® layer can then be applied to the last one of the heating layer 4, i.e. which is the second layer 4b in FIG. 3. This may also be configured as an outer layer for mechanical and/or chemical protection of the medium line. Alternatively, as shown in FIG. 4, leaving the insulating air layer 8 as it is, the corrugated pipe 9 can be added onto the medium line 1 between the outer layer in the form of a polyamide layer 5a and the corrugated pipe 9 as a protecting and insulating outer sheathing. The polyamide layer 5a may be a PA11 or PA12 layer.

The conductors or heating conductors 30, 31 may be arranged in the extruder head of an extrusion facility by means of which the layers of the medium line, in particular the heating layer, are extruded. The conductors or heating conductors can be introduced into the heating layer during the extrusion process or in a separate process following extrusion. In particular, when introducing the conductors or heating conductors during the extrusion process, provision of a rotatable section on the extruder head for outputting the conductors or heating conductors can be advantageous. This makes it easy to generate the desired coiling of the conductors or heating conductors while simultaneously applying them into the extruded heating layer.

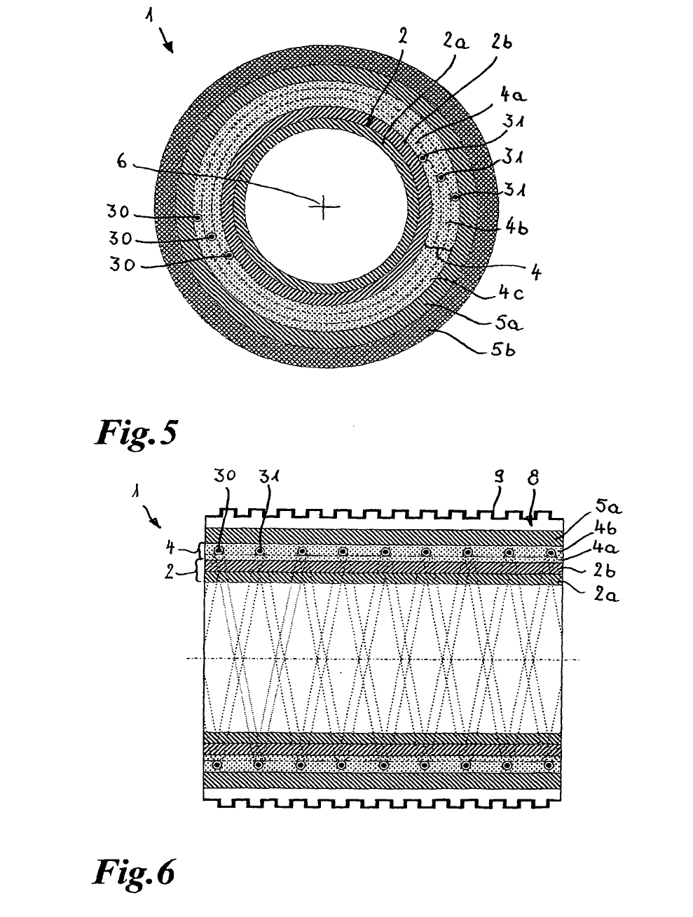

FIG. 5 shows a further embodiment of the medium line 1. This comprises a first layer 2a of the inner layer 2, which is medium-resistant and/or electrically dissipating. A superimposed second layer 2b of the inner layer 2 consists of a polyamide. This has first conductors or heating conductors 30, 31 arranged on it. Between these a first layer 4a of the heating layer 4 is arranged. These have second conductors or heating conductors 30, 31 arranged on them offset relative to the first conductors or heating conductors 30, 31. A second layer 4b of the heating layer 4 is provided between these second conductors or heating conductors. This has third conductors or heating conductors 30, 31 arranged on it. These third conductors or heating conductors 30, 31 are embedded or arranged in or on a third layer 4c of the heating layer 4. The layers 4a, 4b, 4c of the heating layer 4 consist of polyamide, e.g. conductively filled PA12.

An outer polyamide layer 5a is arranged within, or on top of, the third layer 4c of the heating layer 4 and the conductors or heating conductors 30, 31. The layers 2b, 4a, 4b, 4c including the conductors or heating conductors 30, 31 embedded therein and the layer 5a together form a firm structure. The outer polyamide layer 5a has an insulating layer, here the outer layer 5, arranged on it. This may also be electrically conducting. Individual conductors or heating conductors 30, 31 of the three conductors or heating conductor layers can be disconnected or connected, wherein respectively, positive conductors and negative conductors are provided. The heat supply can thus be selectively controlled or regulated.

FIG. 6 shows a further variant of the medium line 1, where again a first layer 2a of the inner layer 2 is provided in the form of a medium-resistant and/or electrically dissipating layer and is covered by a second layer 2b of the inner layer in the form of a polyamide layer. This has a first layer 4a of the heating layer 4 arranged on it. Conductors or heating conductors 30, 31 are embedded therein or arranged thereon and are covered by a second layer 4b of the heating layer 4, which again is arranged between the conductors or heating conductors 30, 31. The second layer 4b of the heating layer 4 is superimposed by the outer polyamide layer 5a. This is encased by the corrugated pipe 8 as a protecting element, leaving the insulating air layer 8 in place. The construction of the medium line wall is thus similar to the construction of the embodiment in FIG. 4, wherein it is different therefrom in that the inner layer in FIG. 6 is formed of two layers. The outer polyamide layer 5a may, as shown, be single or multi-layer and comprise, for example, an electrostatically dissipating barrier layer.

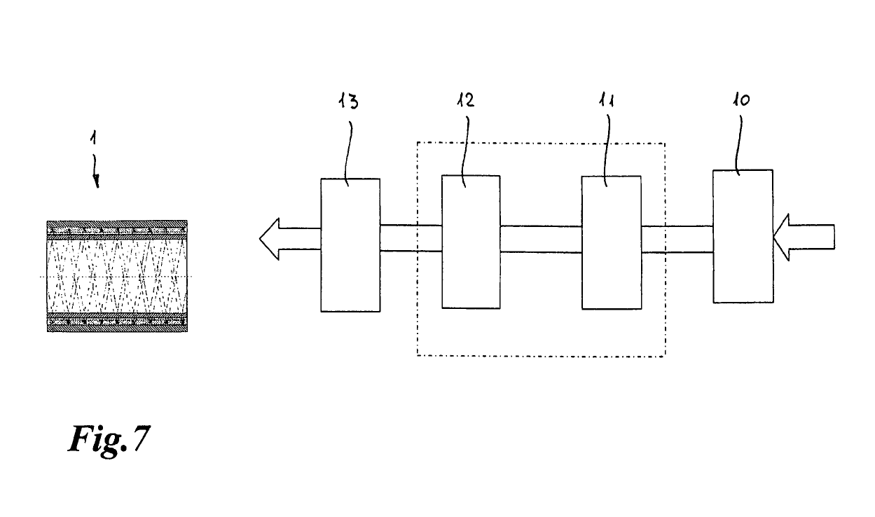

In FIG. 7 the individual steps of an alternative manufacturing process for manufacturing the medium line 1 have been sketched. In a first step or a first station 10 the single-layer or multi-layer inner layer 2 of a pipe line part is manufactured. This is followed by applying the single-layer or multi-layer heating layer 4. At a second station 11 or in a second step the pipe line part provided with the inner layer 2 and the single- or multi-layer heating layer 4 is locally heated, in particular by flaming, infrared radiation, hot air, laser beam treatment etc. Localized heating is carried out up to the melting point of the heating layer 4 or its outermost layer or one of the further layers thereof. Advantageously, however, the innermost layer 4a of the heating layer 4 is not heated up to melting point. If processing results in the heating layer 4 being still warm, additional heating in step or station 11 may be omitted.

At the third station or in a third step 12 the conductors or heating conductors 30, 31 are wrapped around the pipe line part. As a result the conductors or heating conductors 30, 31 penetrate into the molten layer(s) of the heating layer 4. In order to avoid that the conductors or heating conductors 30, 31 penetrate into the inner layer 2, the innermost layer 4a of the heating layer 4 is not melted i.e. possibly cooled in order not to soften and so as to permit applying the conductors or heating conductors 30, 31 onto the same, when this is desired.

The stations 11 and 12 can be combined or integrated to form one station.

In a fourth step or at a fourth or third station 13 the single- or multi-layer outer layer 5 is applied thereby creating the medium line 1 provided with at least the three layers 2, 4 and 5.

Alternatively to localized heating of the heating layer 4 a pipe line part can be provided, which already comprises the inner layer 2, the single- or multi-layer heating layer 4 and the outer layer 5a. To embed the conductors or heating conductors 30, 31 therein, these are heated and wrapped around the outside of the outer polyamide layer 5a while applying a force which is directed radially inwards with regard to the pipe line part so that the conductors or heating conductors 30, 31 penetrate into the heating layer up to a desired depth and thus thereafter also lie at a predetermined radial depth. Sealing the outer polyamide layer 5a, which comprises slots or grooves due to the conductors locally introduced from outside, can be achieved by heating its surface so as to close it. Alternatively a covering layer can be applied.

In variation to the above methods the heated conductors or heating conductors 30, 31 can also be introduced prior to applying the outer polyamide layer 5 from outside into the single- or multi-layer heating layer 4. The outer polyamide layer 5a then covers the heating layer 4. Protection or insulation towards the outside against mechanical and chemical influences may be ensured by providing a chloroprene layer 5b or by providing a corrugated pipe 9. Both variants also permit electric insulation of the medium line.

Barrier layers can be arranged between all or individual single- and multi-layer layers of the medium line 1 in the above described variants.

Apart from the various embodiments of multi-layer electrically heatable medium lines described above and illustrated in the figures with their features being capable of being combined with each other, numerous further embodiments are feasible, wherein the electric conductors or heating conductors are respectively arranged coiled within the heating layer in longitudinal direction of the medium line in a radially and/or axially predetermined position within the heating layer.

### REFERENCE LIST

1 medium line
2 inner layer
2a first layer
2b second layer
4 heating layer
4a first layer/innermost layer
4b second layer
4c third layer
5 outer layer
5a polyamide layer/outer layer
5b chloroprene layer
6 longitudinal axis
7 barrier layer
8 air layer
9 pipe
10 first station
11 second station
12 third station
30, 31 heating conductors
43 heating layer

1. A multi-layer electrically heatable medium line, comprising a medium-resistant inner layer, a heating layer comprising at least two conductors or heating conductors and an outer layer,
wherein the layers of the medium line are single-layer or multi-layer and the conductors or heating conductors, in a longitudinal direction of the medium line, are embedded coiled in a radially and/or axially predetermined position within the heating layer.

2. The medium line according to claim 1, wherein the conductors or heating conductors are coated, but provided without an enveloping insulating layer.

3. The medium line according to claim 2, wherein the coating is a metal coating, with a layer thickness of 1 to 3 μm.

4. The medium line according to claim 1, wherein the heating layer is configured as a heat-conducting layer or an electrically conducting layer.

5. The medium line according to claim 1, wherein the single-layer or multi-layer inner layer or at least one layer of the inner layer is configured as a barrier layer and/or the barrier layer is provided between the heating layer and the inner layer.

6. The medium line according to one of the preceding claims claim 1, wherein the outer layer is electrostatically dissipating and/or insulating.

7. The medium line according to claim 1, wherein at least a corrugated pipe is provided as a protecting and insulating outer sheathing of the medium, wherein an insulating air volume is provided between the outer layer of the medium line and the corrugated pipe.

8. The medium line according to claim 1, wherein the inner layer is electrostatically dissipating.

9. The medium line according to claim 1, wherein at least one adhesion promoting layer and/or barrier layer is provided between the inner layer and the heating layer.

10. A method for manufacturing a multi-layer electrically heatable medium line wherein a single-layer or multi-layer inner layer is manufactured, comprising the steps of:
applying a first layer of a heating layer to the inner layer for arranging conductors or heating conductors in a defined position in a wall of the medium line,
applying at least two conductors or heating conductors to this first layer of the heating layer,
applying a second layer of the heating layer, wherein the conductors or heating conductors (30, 31) are embedded into the second layer of the heating layer, and
applying a single-layer or multi-layer outer layer to the second layer or at least one further layer of the heating layer.

11. The method for manufacturing a single-layer or multi-layer electrically heatable medium line wherein a single-layer or multi-layer inner layer is manufactured, comprising the steps of:
applying a heating layer to the inner layer as a single- or multi-layer layer,
locally heating or heating until partially melting the heating layer,
introducing at least two conductors or heating conductors in a coiled arrangement across a longitudinal extension of the medium line, and
applying a single-layer or multi-layer outer layer to the heating layer.

12. The method according to claim 11, wherein localized heating is provided such that at least an outermost layer of the heating layer is heated up to a boiling point, or the heating layer is heated to a predetermined depth up to its melting point.

13. The method according to claim 11, wherein the heating is effected via flaming, hot air, infrared radiation, or laser beam treatment.

14. The method according to claim 12, wherein if the melting point is exceeded, the heating layer or the respective layer of the heating layer is cooled.

15. The method for manufacturing a multi-layer electrically heatable medium line according to claim 1,
a single-layer or multi-layer inner layer is manufactured,
a single-layer or multi-layer heating layer is applied onto the inner layer,
a single-layer or multi-layer outer layer is applied onto the heating layer,
at least two conductors or heating conductors are heated and, prior to or after applying the outer layer, are introduced into the heating layer from the respective outside of the heating layer or outer layer up to a predetermined depth.

16. The method according to claim 12, wherein the layer of the heating layer onto which the conductors or heating conductors are applied, consists of a material with a melting point which is higher than the melting point of the layer(s) above it.

17. The method according to claim 10, wherein at least the layer(s) of the heating layer is/are applied by extrusion and/or in that the conductors or heating conductors are wrapped in one or several layers onto the one or several layer(s) of the heating layer.

18. A device for performing the method according to claim 10, wherein the device comprises at least one extruder head with a conductor or heating conductor feeding facility for embedding the conductors or heating conductors while extruding the heating layer, wherein the conductor or heating conductor feeding facility comprises conductor or heating conductor output openings concentrically to an extrusion opening of the extruder head, and wherein the conductor or heating conductor feeding facility is configured so as to be rotatable about the extrusion opening.

19. The medium line according to claim 2, wherein the metal coating is a nickel coating or a tin coating, wherein the heating layer comprises at least an extrudable plastic material, wherein the single-layer or multi-layer inner layer or at least one layer of the inner layer is configured as a laser-impermeable barrier layer and/or or the barrier layer is provided between the heating layer and the inner layer, wherein the outer layer is an insulating foamed outer layer, and wherein at least one adhesion promoting and/or barrier layer is provided between the inner layer and the heating layer and is formed from a polymer-modified polyvinylidenfluoride homopolymer (PVDF).

20. The medium line according to claim 19, wherein the laser-impermeable barrier layer is a fluoropolymer material, and wherein the outer layer is a chloroprene layer.
